(19) United States
(12) Patent Application Publication
(10) Pub. No.: US 2022/0340736 A1
(43) Pub. Date: Oct. 27, 2022

(54) Homogeneous fiber product based on bio-oil and/or water and method for their production

(71) Applicant: Aalto University Foundation sr, Aalto (FI)

(72) Inventors: Olli Dahl, Tervakoski (FI); Antti Pietiläinen, Helsinki (FI); Timo Pekkarinen, Tampere (FI)

(21) Appl. No.: 17/760,793

(22) PCT Filed: Sep. 16, 2020
(86) PCT No.: PCT/FI2020/050588

§ 371 Date: Mar. 16, 2022

(30) Foreign Application Priority Data
Sep. 16, 2019 (FI) 20195766

(51) Int. Cl. C08L 1/04; C08B 15/02; C08B 15/08; A23L 33/24; A23D 9/007; A23D 9/04; A23L 27/60; A23G 1/40; A23L 2/52; A23C 9/13; A23G 1/36

(52) U.S. Cl. CPC C08L 1/04; C08B 15/02; C08B 15/08; A23L 33/24; A23D 9/007; A23D 9/04; A23L 27/60; A23G 1/40; A23L 2/52; A23C 9/1307; A23G 1/36; A23C 9/1315; C08L 2205/16; A23V 2002/00

(57) ABSTRACT

The present invention relates to typically homogeneous gel-like cellulose-based fiber products which do not contain hemicellulose but may nevertheless contain lignin. The invention relates also to a method for the production of such fibrous products, in which microcrystalline cellulose (MCC) is mixed into oil or water to form a fiber mixture, and is degraded into homogeneous form by mechanical treatment.

### FIELD OF THE INVENTION

The invention relates to homogeneous cellulosic fibrous products in gel-like form which contain hardly any hemicellulose (may also contain lignin).

In the future, there is a desire to increase the use of bio-based raw materials in various applications and at the same time replace non-renewable or fossil raw materials. Such applications exist e.g. in food, natural products, medicines, plastics, coatings, and many other products.

Cellulose is the most common bio-based material and polymer in the world. Cellulose is obtained from many sources such as plants and trees. In the most sustainable manner, cellulosic fibers or, most commonly, pulp can be produced by chemical methods from wood. The most common methods are either sulfate- or sulfite-based, but solvent-based methods are also known. The sulphate and sulphite process can be used to produce both paper and dissolving pulp. The difference between the above cellulose grades is the hemicellulose content, which is attempted to be minimized in soluble pulp and maximized in paper pulp.

If the fiber is not bleached, it contains lignin and hemicellulose in addition to cellulose. When the pulp is bleached, lignin is removed, leaving only fiber containing hemicellulose and cellulose. Typically, the pulp fiber is 0.5 to 4 mm long and has a diameter of about one hundredth of its length. In addition, the fibers have a fiber wall with a thickness of a few micrometers.

Particulate cellulose can be made from fibrous cellulose, whereby its physical structure is disrupted. This can be done both chemically and mechanically. In the chemical method, the fibrous structure is degraded, for example, with concentrated mineral acid, whereby hemicellulose is removed from the fiber at the same time. In this case, microcrystalline cellulose i.e. MCC is obtained.

If the fiber prepared in the above manner is mechanically treated, MFC, i.e. microfibrillated cellulose is obtained. Both methods are currently known in the art.

Aalto University has, however, developed a new and cost-effective way to make MCC, also known as AaltoCell™. The brand covers both the end product and the process by which MCC is made. In addition, AaltoCell™-based microcrystalline cellulose may be either pure cellulose or may also contain lignin in the fiber if the fiber has not been bleached to remove lignin. Lignin-containing microcrystalline cellulose is a completely new product that has never been on the market.

Said technique is based on the production of microcrystalline cellulose, i.e. MCC, by the chemical method, in which case the final MCC is essentially free of nanoparticles and hemicellulose.

### BACKGROUND OF THE INVENTION

It is known that it is possible to make gel from fibrous pulp by mechanical grinding in the aqueous phase. In such a case, however, use is made of mechanically produced microfibrillated cellulose, whereby it is a water-based MFC fiber mixture having in addition to microparticles also nano-sized particles and further containing also hemicellulose in addition to cellulose.

In addition, it is known that such fibrous MFC pulp can be mechanically treated in the oil/water phase, and an oily MFC fiber mixture is obtained which also contains various amounts of water.

The challenge with the above process is that the feed consistency is in all cases less than 3% with respect to the fiber, typically 1-2%, which significantly increases the energy costs of the process.

In addition, the above-mentioned part of the cellulose particles contained in MFC in both the oil and water phases is mostly nano-sized, the health effects of which are still unknown. Products made in this way do not meet the requirements of the food or pharmaceutical industry, whereby their potential use in final products requires long-term and expensive investigations.

Based on the above, there has been a clear need to develop a new water- and oil-based fiber product that is of acceptable food and drug grade, homogeneous, and the particles in it are micro-sized—not nano-sized. In addition, a method operating at high consistencies would be advantageous.

### SUMMARY OF THE INVENTION

It is therefore an object of the invention to provide a new method for the production of an oil- or water-based homogeneous fiber product by using chemically produced microcrystalline cellulose (MCC) as raw material from which hemicellulose has been substantially removed.

In addition, it is an object of the invention to provide a method for the production of an oil- or water-based homogeneous fiber product, in which method high feed consistencies can be used.

In the new method developed by us, dried or more preferably undried MCC that contains either lignin and cellulose, or contains only cellulose (note: undried MCC is only available as AaltoCell™ based product), can be made into either an oil- or water-based homogeneous fiber product (partially hydrophobic or hydrophilic, gel-like cellulose fiber product) wherein the microcrystalline cellulose can be degraded into a gel-like form by a two-stage mechanical method, FIG. 1.

Small amounts of water are also typically present in oil-based mixtures, but separate addition of this water is typically not necessary because the preferred microcrystalline cellulose as such already contains water.

Numerous advantages are achieved with the invention. Among other things, the consistency of the water- or oil-based mixture formed from MCC, with respect to the fiber, when the mixture is fed to the mechanical treatment, can be kept at a high level, whereby the energy consumption of the process remains low.

Because MCC is used, a product is obtained in which no significant amounts of nano-sized particles are present. Thereby a product is obtained, the health effects of which have been investigated, whereby the fiber product according to the invention meets the requirements of the food and pharmaceutical industry.

By using the two-stage mechanical treatment according to the invention, MCC is made to restructure and distribute evenly, among other things, into various grades of oil, such as, for example, vegetable oil or cocoa butter, or into the aqueous phase. When being successful, the method requires that the oil-based gel-like mixture contains a small amount of water before introducing the oil-fiber mixture into the above-mentioned mechanical device, typically at least 2% water. A small amount of water will bring about cavitation in the device, whereby the state of the fiber changes and adopts its final shape thanks to the small nozzle through which the fiber mixture is finally passed.

### BRIEF DESCRIPTION OF THE DRAWINGS

FIG. 1. An example of the operating principle of the two-stage device, whereby both water- and oil-based gels are obtained from an undried AaltoCell™ fiber product.

FIG. 2. Shown on the left side is a water-based gel-like cellulose fiber mixture with a feed consistency/final product consistency of 10%, and on the right side a pulp/lignin-based gel-like mixture with a feed consistency/final product consistency of 10%.

FIG. 3. Oil-based gel-like cellulose fiber mixture with a feed consistency of 8%.

FIG. 4. Shown in the middle of the figure is an aqueous gel-like mixture prepared with a feed consistency of 10% and diluted with water to a consistency of 1.5%. As shown in the figure, MCC without mechanical treatment is on the left and MCC with mechanical treatment with a feed consistency of 15% on the right.

### DEFINITIONS

In the present context, the term “homogeneous fiber product” comprises a mixture or hydrocolloid having a partially hydrophobic or hydrophilic gel form.

“MCC”, i.e. microcrystalline cellulose, comprises particulate (microcrystalline) cellulose produced from fibrous cellulose by chemical degradation, from which hemicellulose has been removed at the same time. It can be either unbleached or bleached.

In the present context, “mechanical treatment” thus refers to a first pressurized treatment step of the MCC-containing mixture, by which cavitation is achieved, resulting in deterioration of the particle structure and possibly partial defiberization, and a second treatment step, in which the mixture is passed by applying pressure through a small gap in the treatment apparatus, whereby the weakened portion of the mixture can be further treated in order to mix the particles of the mixture into a homogeneous fibrous product.

“Cavitation” in turn, refers to the modification of fibers by the flow of the mixture (and the bubbles created by it), typically by weakening the fiber structure.

### DETAILED DESCRIPTION OF THE EMBODIMENTS

The present invention relates to a method for preparing an oil- or water-based homogeneous fiber product from microcrystalline cellulose (MCC). In this method, the MCC is mixed with oil or water, or a mixture thereof, into a fiber mixture, and can be degraded to a homogeneous form by a two-stage mechanical treatment.

A typical liquid in the fiber mixture is water or oil, in which latter case there is also some water in the fiber.

The MCC is typically either unbleached, in which case it contains both lignin and cellulose, or bleached, being only cellulosic. Preferably it is unbleached, in which case it is lignin-containing microcrystalline cellulose.

The MCC can also be either dried or undried. Preferably, however, the MCC is undried, which facilitates obtaining a homogeneous, gel-like mixture.

Prior to mechanical treatment, the MCC is converted into a fiber mixture by mixing the MCC with oil or water.

However, if an oil-based mixture is used, the mixture typically contains 0.5 to 20% by weight, preferably 1 to 10% by weight, of water. Preferably, the oil-based mixture contains at least 1% water and 1% fiber. Typically, all concentrations are expressed as weight percents.

The oil is selected from liquid oils or oils that become liquid when the temperature rises to temperatures >20° C. Preferably, an oil of vegetable or animal origin, or a fossil oil is selected. Most suitably, however, the oil is selected from edible oils such as linseed oil, mustard oil, almond oil, soybean oil, hemp oil, palm oil, peanut oil, castor oil, coconut oil or corn oil, typically from vegetable oils such as rapeseed oil, canola oil, sunflower oil, olive oil, or cocoa butter.

A special feature of the method of the invention is that higher consistencies than before can be used when feeding the oil or water-based fiber mixture to mechanical treatment. Preferably, this feed consistency is 5 to 20% by weight, more preferably 10 to 15% by weight, based on the fiber.

In order to make the mechanical treatment as efficient as possible, a two-stage mechanical treatment is used.

According to an embodiment of the invention, in the first step of the two-stage mechanical treatment, a treatment is performed in which the liquid portion of the fiber mixture is made to cavitate, whereby the structure of the fiber particle changes, typically softens.

According to a second embodiment of the invention, in the second step of the two-stage mechanical treatment, the portion of the fiber particle that was structurally altered in the first step is caused to separate into fibers when the mixture is passed through a small gap by means of pressure.

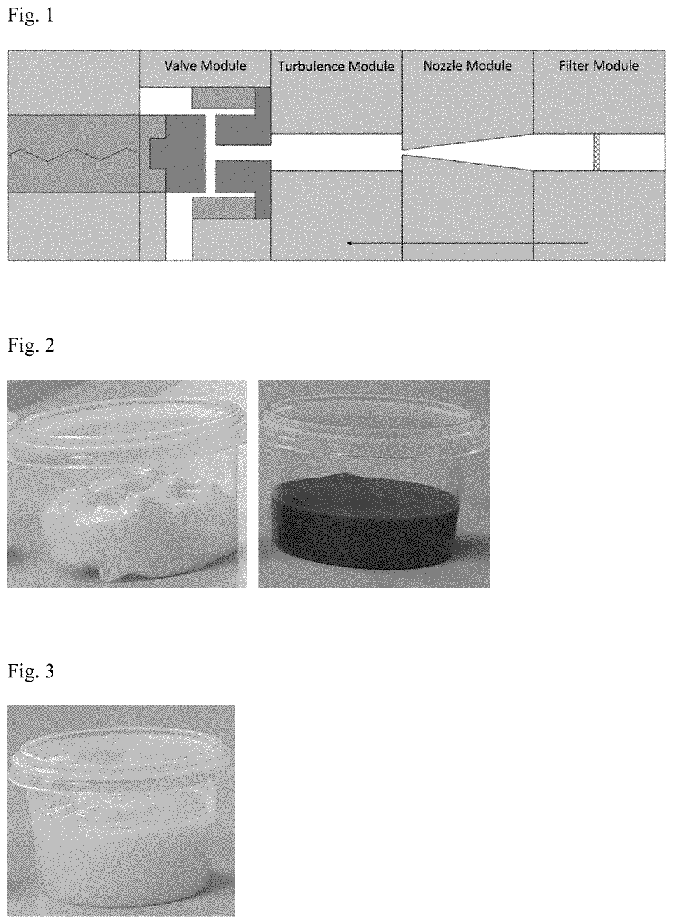

In one exemplary embodiment, an oil-based gel-like cellulosic fiber mixture was prepared in the tests as follows: undried AaltoCell™ fiber blend in which AaltoCell pulp with a moisture content of 50% was mixed with rapeseed oil so that the mixtures contained 2, 4, 6 and 8% of both fiber and water. When passing such mixtures through the apparatus of FIG. 1 it was found that the fiber product is degraded as it would in the aqueous phase, but makes a homogeneous mixture with the oil. This phenomenon has not been previously observed or publicly reported.

As shown in FIG. 1, such a device may typically have a filter module, a nozzle module, a turbulence module, and a valve module.

A water-based gel-like cellulosic fiber mixture was prepared in a similar way, but without oil, achieving a maximum feed consistency of 15%, but most preferably 10%.

In the past, MCC or MFC dried by different methods has been merely mixed with oil, the problem being an inhomogeneous mixture in which the fibers have formed lumps in the oil. The mixture obtained by the method described above is homogeneous and forms with the fiber an oil mixture in which the oil does not separate from the fiber, whereby it is possible to speak of an oil-based gel-like cellulose fiber mixture produced in a new manner.

Water-based cellulose gel has also been prepared in the past, but a MFC gel obtained with a low feed density and still in the above-mentioned manner contains nano-sized particles, which are not produced by our method, all particles instead being micro-sized, at least substantially.

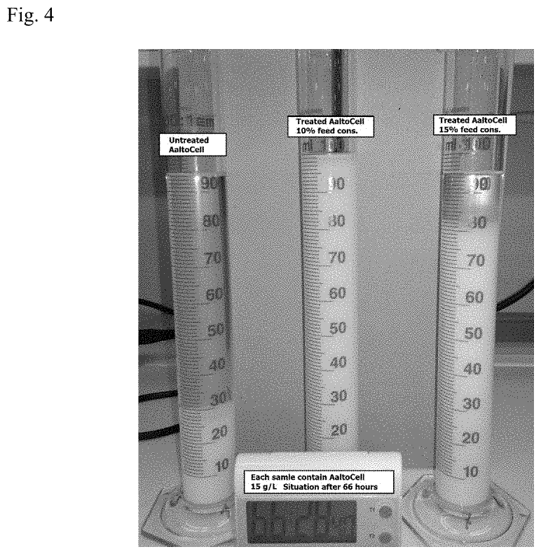

Shown in FIG. 4 is a water-based gel-like mixture prepared at 10% feed consistency by the previously described mechanical method and diluted to 1.5% consistency. This yielded a hydrocolloid which was evenly distributed in the aqueous solution and did not settle even over 66 h.

The present invention also relates to a product prepared by the described method. Because MCC is used as a source of cellulose in the method of the present invention, a product can be produced in which no significant amounts of nano-sized particles are present. The health effects of this kind of product have been investigated, whereby the fiber product according to the invention meets the requirements of the food and pharmaceutical industry.

Thus, the product according to the invention can be used in foodstuffs, and accordingly also in pharmaceutical additives.

Preferably, the oil-based AaltoCell™-based gel-like mixture prepared by the method described above can be used in fat- and oil-based foods to improve e.g. mouthfeel, such as in mayonnaise, chocolate, and salad dressings. In addition, it can be used in plastics to which hydrophilic fibers are added. In this case, the adhesion of the hydrophilic fiber in plastic products can be improved, whereby the strength properties of the composite are significantly improved and its production is facilitated when the oil reduces friction e.g. in extruder-type mixers.

The water-based AaltoCell™-based gel-like mixture prepared by the method described above can in turn be advantageously used in foods to improve the mouthfeel of the final product, such as in mustards, ketchups, yoghurts, juices and sports drinks.

### The Embodiments

Embodiment 1. A mechanical method for producing water- and oil-based high-consistency gel-like cellulose fiber mixtures in which the particle size is predominantly of microsize and the mixture contains hardly any nano-sized particles.

Embodiment 2. A mechanical method for producing water- and oil-based high-consistency gel-like cellulose fiber mixtures in which the particle size is of microsize and the mixture contains no nano-sized particles.

Embodiment 3. The mechanical method typically requires two stages, in which in the first step the liquid portion of the fiber mixture, which is aqueous, is made to cavitate, whereby the fiber particle softens and can partially separate into fibers. In the second step, the defiberization of the softened portion of the fiber particle can be completed.

Embodiment 4. A mechanical method wherein an oil-based gel-like mixture is obtained when the oil-based mixture also contains water, enabling that cavitation step, and also the oil is made to distribute evenly in the gel-like mixture. Preferably, there is at least 2% water in the oil-based mixture, and more preferably 8%.

Embodiment 5. A mechanical method wherein prior to mechanical treatment, a fiber mixture is formed in which MCC is added to a water- or oil-based liquid to a consistency of 5 to 20% by weight based on the fiber.

1. A method for producing an oil- or water-based homogeneous fiber product from microcrystalline cellulose (MCC), wherein the MCC is mixed with oil or water, or a mixture thereof, into a fiber mixture and is degraded into homogeneous form by a two-stage mechanical treatment.

2. The method according to claim 1, wherein the MCC is either unbleached lignin- and cellulose-containing MCC, or bleached cellulose-containing MCC.

3. The method according to claim 1, wherein an oil-based fiber mixture including 0.5 to 20% by weight of water, preferably 1 to 10% by weight, is formed from the MCC.

4. The method according to claim 1, wherein the MCC is mixed into an oil-based fiber mixture having at least 1% water and at least 1% fiber in the oil, or preferably into an oil-based fiber mixture having at least 2% water in the oil.

5. The method according to claim 1, wherein the oil is selected from liquid oils or oils that become liquid when the temperature rises to temperatures of >20° C.

6. The method according to claim 1, wherein the consistency when feeding the oil- or water-based fiber mixture to mechanical treatment is 5 to 20% by weight, preferably 10 to 15% by weight, with respect to the fiber.

7. The method according to claim 1, wherein the MCC is mixed into a water-based fiber mixture having a feed consistency of 10%, or a maximum of 15%, when being fed to mechanical treatment.

8. The method according to claim 1, wherein the MCC is mixed into an oil-based fiber mixture having a feed consistency of 5 to 10% with respect to the fiber when being fed to mechanical treatment.

9. The method according to claim 1, wherein in the first step of the two-stage mechanical treatment, the liquid part of the fiber mixture is made to cavitate, whereby the structure of the fiber particle weakens, typically softens and partially separates into fibers.

10. The method according to claim 1, wherein in the second step of the two-stage mechanical treatment, the particles of the fiber particle that were structurally weakened and partially separated into fibers in the first step are mixed into a homogenous fiber product when the mixture is passed through a small gap by means of pressure.

11. The method according to claim 1, wherein a fiber product is produced in which the particle is predominantly of microsize.

12. An oil- or water-based homogeneous fiber product, wherein it has been produced from microcrystalline cellulose (MCC) by a method for producing an oil- or water-based homogeneous fiber product from microcrystalline cellulose (MCC), wherein the MCC is mixed with oil or water, or a mixture thereof, into a fiber mixture and is degraded into homogeneous form by a two-stage mechanical treatment.

13. The oil- or water-based homogeneous fiber product according to claim 12, wherein it is MCC-based and contains either unbleached lignin- and cellulose-containing MCC or bleached cellulose-containing MCC.

14. Use of the oil-based homogeneous fiber product produced according to claim 1 in fat- and oil-based foods.

15. The use according to claim 14 in mayonnaises, chocolates or salad dressings, or in plastics by adding hydrophilic fibers.

16. Use of the water-based homogeneous fiber product produced according to claim 1 in foods such as mustards, ketchups, yoghurts, juices and sports drinks.

17. The method according to claim 5, wherein the oil is selected from oils of vegetable or animal origin, or fossil oils.

18. The method of claim 5, wherein the oil is selected from edible oils.

19. The method of claim 5, wherein the oil is selected from; linseed oil, mustard oil, almond oil, soybean oil, hemp oil, palm oil, peanut oil, castor oil, coconut oil or corn oil.

20. The method of claim 5, wherein the oil is selected from rapeseed oil, canola oil, sunflower oil, olive oil, or cocoa butter.
